(19) United States
(12) Patent Application Publication
(10) Pub. No.: US 2018/0260306 A1
(43) Pub. Date: Sep. 13, 2018

(54) Unexpected Path Debugging

(71) Applicant: International Business Machines Corporation, Armonk, NY (US)

(72) Inventors: James E. Carey, Rochester, MN (US); Jim C. Chen, Rochester, MN (US); John M. Santosuosso, Rochester, MN (US)

(21) Appl. No.: 15/716,591

(22) Filed: Sep. 27, 2017

Related U.S. Application Data
(63) Continuation of application No. 15/453,201, filed on Mar. 8, 2017.

(51) Int. Cl. G06F 11/36; G06F 9/54; G06F 3/0482

(52) U.S. Cl. CPC G06F 11/3664; G06F 3/0482; G06F 9/542; G06F 11/3636

(57) ABSTRACT

In an approach for visualizing a code path, a processor runs source code through a code profiler. A processor associates a time stamp with a first line of code as the first line of code is executed. A processor assigns a visual indicator to the first line of code based, at least in part, on the time stamp. A processor displays the source code and the visual indicator assigned to the first line of code.

### BACKGROUND

The present invention relates generally to the field of code debugging, and more particularly to visualizing code paths taken while debugging.

In computer programming, debugging involves identifying a problem, isolating the source of the problem, and then either correcting the problem or determining a way to work around it. In software development, debugging involves locating and correcting code errors in a computer program. The debugging process starts as soon as code is written and continues in successive stages as code is combined with other units of programming to form a software product.

Code profiling is a form of dynamic program analysis that measures the space or time complexity of a program, the usage of particular instructions, or the frequency and duration of function calls. Profiling is achieved by instrumenting either the program source code or its binary executable form using a tool called a profiler. Profilers may use a number of different techniques, such as event-based, statistical, instrumented, and simulation methods.

### SUMMARY

Aspects of an embodiment of the present invention disclose a method, computer program product, and computer system for visualizing code paths. A processor runs source code through a code profiler. A processor associates a time stamp with a first line of code as the first line of code is executed. A processor assigns a visual indicator to the first line of code based, at least in part, on the time stamp. A processor displays the source code and the visual indicator assigned to the first line of code.

### BRIEF DESCRIPTION OF THE DRAWINGS

FIG. 1 is a functional block diagram illustrating a code debugging environment, in accordance with an embodiment of the present invention;

FIG. 2 is a flowchart depicting operational steps of a highlighting function as an add-on to a profiler, on a computing device within the code debugging environment of FIG. 1, in accordance with an embodiment of the present invention;

FIG. 3 is a flowchart depicting operational steps of highlighting function as an add-on to a debugger, on a computing device within the code debugging environment of FIG. 1, in accordance with an embodiment of the present invention; and

FIG. 4 depicts a block diagram of components of the computing device executing the highlighting function, in accordance with an embodiment of the present invention.

### DETAILED DESCRIPTION

Embodiments of the present invention recognize the importance of visualizing a code path taken while debugging code. Code profilers focus on which code has been visited, how often code is used, and visualize more heavily used code. However, code profilers do not visualize the time-frame of when a line or segment of code was visited. Thus, embodiments of the present invention recognize that there is a need for an approach that better visualizes, time-wise, the code path taken and shows how often code is executed as applied to multi-threaded applications. Embodiments of the present invention provide an add-on to a profiler and/or debugger that improves visualization of a code path by adding visual indicators to individual lines of code based on a line of code's proximity, timewise, to a breakpoint or to when the line of code was last executed, for example, highlighting lines of code in varying degrees of color. Embodiments of the present invention provide a visualization of how often code is executed, such as in a bar graph. Embodiments of the present invention provide this visualization as applied to multi-threaded applications. Embodiments of the present invention provide breakpointing when there is a variance from historic times between times executing or a variance in the number of times code executes. In this manner, as discussed in greater detail herein, embodiments of the present invention involve adding visual indicators to lines of code to show time-wise when the code was last executed, visualizing how often code is executed in multi-threaded applications, and breakpointing when variances to historic information occur.

The present invention will now be described in detail with reference to the Figures.

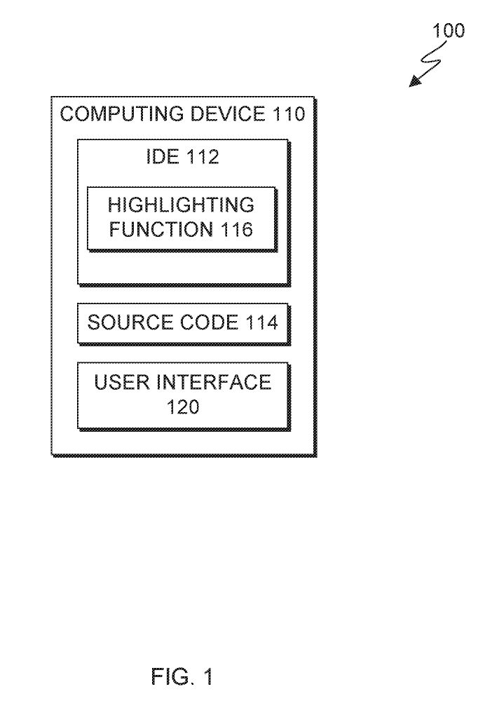

FIG. 1 depicts a diagram of code debugging environment 100, in accordance with an embodiment of the present invention. FIG. 1 provides only an illustration of one embodiment and does not imply any limitations with regard to the environments in which different embodiments may be implemented. In the depicted embodiment, code debugging environment 100 includes computing device 110. Code debugging environment 100 may include additional computing devices, servers, computers, mobile devices, or other devices not shown.

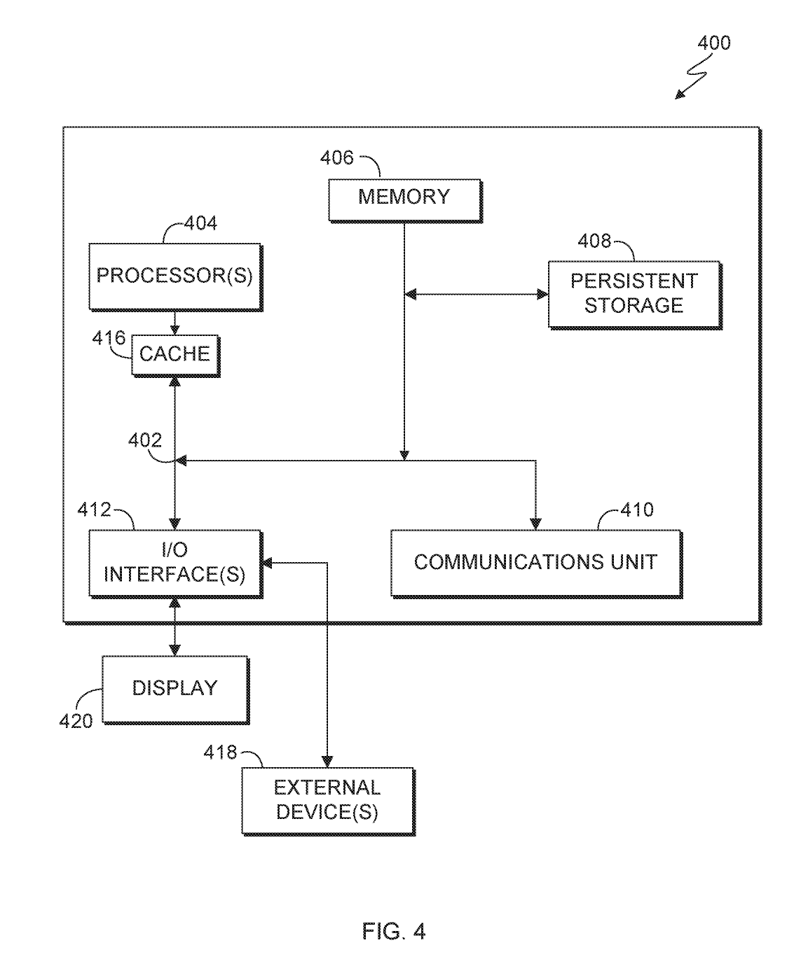

Computing device 110 operates to run integrated development environment (IDE) 112 and user interface 120, and store source code 114. In an embodiment, computing device 110 may be a laptop computer, tablet computer, netbook computer, personal computer (PC), a desktop computer, a smart phone, or any programmable electronic device. In other embodiments, computing device 110 may be a management server, a web server, or any other electronic device or computing system capable of running a program and receiving and sending data. In other embodiments, computing device 110 may represent a server computing system utilizing multiple computers as a server system, such as in a cloud computing environment. In the depicted embodiment, computing device 110 contains IDE 112, source code 114, and user interface 120. Computing device 110 may include components as depicted and described in further detail with respect to FIG. 4.

IDE 112 is an integrated development environment that is a software application that provides comprehensive facilities to computer programmers for software development. IDE 112 may contain a source code editor, build automation tools, profilers, and debuggers. In some embodiments, IDE 112 contains a compiler and/or interpreter. In some embodiments, IDE 112 contains a class browser, an object browser, and a class hierarchy diagram, for use in object-oriented software development. In one embodiment, IDE 112 includes highlighting function 116. In one embodiment, IDE 112 resides on server 20. In another embodiment, IDE 112 may reside on another computing device, provided that IDE 112 has access to source code 114, and provided that IDE 112 is accessible to a user through user interface 120.

Source code 114 is a generic program that includes source code for analysis by IDE 112 and highlighting function 116. Source code 114 may be written in COBOL, C++, Smalltalk, or other programming languages. In embodiments of the present invention, source code 114 is run through a profiler and/or debugger of IDE 112. In some embodiments, source code 114 resides on computing device 110. In other embodiments, source code 114 may reside on another computing device, provided that source code 114 is accessible to IDE 112 and highlighting function 116.

User interface 120 operates on computing device 110 to generate display signals corresponding to content, such as windows, menus, and icons, and to receive various forms of user input. In one embodiment, user interface 120 comprises an interface to highlighting function 116 of IDE 112. User interface 120 may display data received from highlighting function 116 of IDE 112. User interface 120 may send input to highlighting function 116 and IDE 112. User interface 120 may comprise one or more interfaces, such as an operating system interface and/or application interfaces.

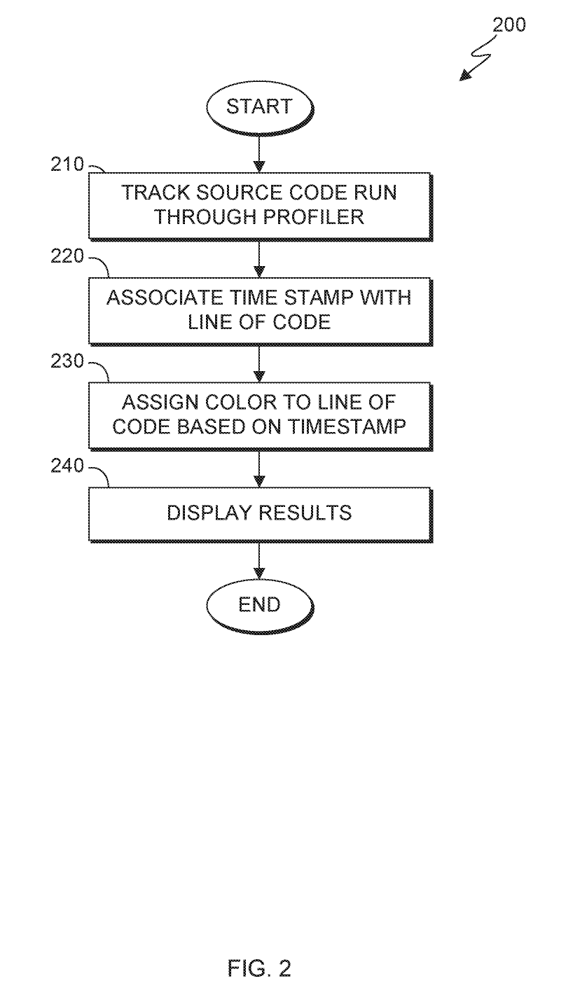

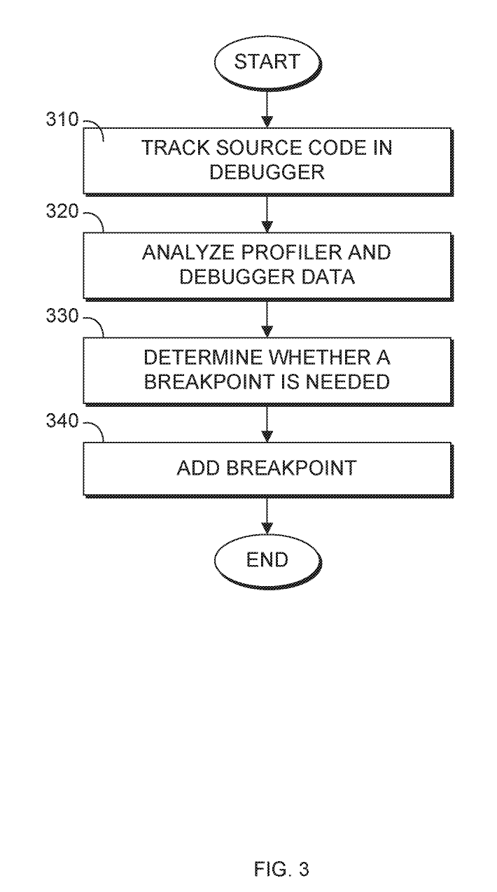

Highlighting function 116 operates as an add-on to a profiler and/or debugger within IDE 112. In a first embodiment, highlighting function 116 operates as an add-on to a profiler of IDE 112 that runs source code, associates a time stamp with a line of code as it is executed, assigns a visual indicator to the line of code based on the time stamp, and then displays the results. This embodiment of highlighting function 116 is described in further detail with respect to FIG. 2. In a second embodiment, highlighting function 116 operates as an add-on to a debugger of IDE 112 that displays the visually indicated profiled lines of code in varying degrees of visual indication based on their proximity, time-wise, to the current call stack as the source code is debugged. Additionally, in this second embodiment, highlighting function 116 analyzes profile information and debug information to determine if a breakpoint should be added, and then based on that determination, adds the breakpoint or not. This second embodiment of highlighting function 116, as an add-on to a debugger, is described in further detail with respect to FIG. 3. In the depicted embodiment, highlighting function 116 of IDE 112 resides on computing device 110. In another embodiment, highlighting function 116 of IDE 112 may reside elsewhere within code debugging environment 100 provided highlighting function 116 of IDE 112 has access to computing device 110.

FIG. 2 depicts a flowchart 200 of the steps of highlighting function 116 as an add-on to a profiler of IDE 112, executing within code debugging environment 100 of FIG. 1, in accordance with an embodiment of the present invention. In the depicted embodiment, highlighting function 116 tracks source code run through a profiler, associates a time stamp with a line of code as it is executed, assigns a visual indicator to the line of code based on the time stamp, and displays the results. It should be appreciated that the process depicted in FIG. 2 illustrates one possible iteration of highlighting function 116, which can repeat each time the source code is run through the profiler.

In step 210, highlighting function 116 tracks source code run through profiler. In an embodiment, highlighting function 116 tracks source code as it is run through a profiler of IDE 112. In other embodiments, highlighting function 116 tracks source code of a multi-threaded application run through a profiler of IDE 112.

In step 220, highlighting function 116 associates a time stamp with a line of code. In an embodiment, highlighting function 116 associates a time stamp with a line of code as it is executed. In an embodiment where a line of code is executed multiple times, highlighting function 116 associates multiple time stamps with the line of code.

In step 230, highlighting function 116 assigns a visual indicator to the line of code based on the time stamp. A visual indicator may be, but is not limited to, highlighting the lines of code with varying highlight colors, changing the font color, bolding the font, changing the font, italicizing the font, and underlining the font. In an embodiment, highlighting function 116 assigns a visual indicator to the line of code based on the time stamp and in relation to the last executed line of code or a specified line of code. For example, highlighting function 116 assigns a red highlight to last lines of code executed, a yellow highlight to lines of code visited in the last 5 minutes, a green highlight to lines of code visited in the last 10 minutes, a blue highlight to lines of code visited in the last 15 minutes, etc. In an embodiment where a line of code is executed multiple times, highlighting function 116 assigns a visual indicator based on the most recent time stamp.

In step 240, highlighting function 116 displays results. In an embodiment, highlighting function 116 displays the results with a profile output. A profile of the source code generally includes, but is not limited to, counts of how often a line of code has been hit, timing of how long it takes to get through a section of code, a caller of what job(s) is running this, thread information of what threads are involved, call stacks, and memory signatures such as allocated memory and memory usage. In another embodiment, highlighting function 116 displays the results separately from the profile output. In an embodiment, highlighting function 116 displays the code highlighted based on the proximity with respect to time from a specified line of code. In an embodiment with multi-threads and/or jobs, highlighting function 116 aggregates results collated across different threads and/or jobs that utilize a line of code. In an embodiment where the source code has been run through the profiler multiple times, highlighting function 116 displays a statistical value that can be used to determine the time to use, which is the time from starting to run the source code until the time a line of code is used. In an embodiment, highlighting function 116 displays a bar graph of how often lines of code are executed.

FIG. 3 depicts a flowchart 300 of the steps of highlighting function 116 as an add-on to a debugger of IDE 112, executing within code debugging environment 100 of FIG. 1, in accordance with an embodiment of the present invention. In the depicted embodiment, highlighting function 116 operates to display the visually indicated lines of code in varying degrees based on their proximity, time-wise, to the current call stack as the source code is debugged. Additionally, in this embodiment, highlighting function 116 analyzes profile information and debug information to determine if a breakpoint should be added, and then based on that determination, adds the breakpoint or not. It should be appreciated that the process depicted in FIG. 3 illustrates one possible iteration of highlighting function 116, which repeats for every time the source code is run through the debugger.

In step 310, highlighting function 116 tracks source code run through debugger. In an embodiment, highlighting function 116 tracks a source code run through a debugger of IDE 112. In an embodiment, highlighting function 116 allows for a view showing the profiled source code to be turned on in the debugger. With this view turned on, highlighting function 116 displays the visually indicated lines of code in varying degrees based on the assigned time stamp and in relation to the current call stack. For example, highlighting function 116 assigns a red highlight to lines of code in the current call stack, but once it has been 5 minutes since those lines of code executed, the highlight color will change to yellow.

In step 320, highlighting function 116 analyzes profile information and debug information. In an embodiment where the source code has been run through the profiler, highlighting function 116 analyzes profile information collected. Profile information includes, but is not limited to, which lines of code have been visited, when lines of code are visited, how often each line of code has been visited, and if the source code has been run through the profiler multiple times, a statistical value used to determine the time to use. In an embodiment where the source code has been run through the debugger previously, highlighting function 116 analyzes debug information. Debug information is a collection of information generated by the compiler or assembler program that describes the application represented by the source code, such as variables (type, scope, location), executable lines, etc.

In step 330, highlighting function 116 determines whether a breakpoint should be added. In an embodiment, highlighting function 116 determines whether a breakpoint should be added based, at least in part, on the profile information and/or debug information showing historic information about the path the source code took. In an embodiment, when there is a deviation from the historic code path, highlighting function 116 determines that a breakpoint should be added at the point in the source code when the deviation occurs. In an embodiment, highlighting function 116 specifies regions of the source code where this determination does not need to occur because the regions have higher/lower deviation values to break. Depending on what the source code is designed to do, there could be places in the source code that have a naturally high deviation of the code path that could trigger false positives. In an embodiment, highlighting function 116 tracks these regions and recognizes that a breakpoint is not needed even though a deviation has occurred.

In step 340, highlighting function 116 adds a breakpoint. In an embodiment, highlighting function 116 adds a breakpoint to the source code at the point where the deviation from the historic code path occurred. In an embodiment, highlighting function 116 adds a visual indicator, such as a highlight color, to the breakpoint.

FIG. 4 is a block diagram depicting components of a computer 400 suitable for executing highlighting function 116 of IDE 112. FIG. 4 displays the computer 400, the one or more processor(s) 404 (including one or more computer processors), the communications fabric 402, the memory 406, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g. microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for highlighting function 116 of IDE 112 may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. Highlighting function 116 of IDE 112 may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for visualizing code paths, the method comprising:
running, by one or more processors, source code through a code profiler;
associating, by one or more processors, a time stamp with a first line of code as the first line of code is executed;
assigning, by one or more processors, a visual indicator to the first line of code based, at least in part, on the time stamp, wherein the visual indicator is a highlight color;
displaying, by one or more processors, the source code and the visual indicator assigned to the first line of code;
running, by one or more processors, the source code through a debugger, wherein the source code is source code for a multi-threaded application;
analyzing, by one or more processors, profile information generated by the code profiler and debug information generated by the debugger;
determining, by one or more processors, to add a breakpoint at a location within the source code based on a deviation from an expected code path, wherein the expected code path is based on previous executions of the source code;
responsive to determining to add the breakpoint, adding, by one or more processors, the breakpoint at the location, wherein the breakpoint is assigned an additional visual indicator;
receiving a selection of a second line of code; and
wherein assigning the visual indicator to the first line of code is further based on a most recent time of execution of the second line of code.
